(19) United States
(12) Patent Application Publication
(10) Pub. No.: US 2011/0113930 A1
(43) Pub. Date: May 19, 2011

(54) Open end ratchet wrench

(75) Inventor: Ferry Liao, Taichung (TW)

(73) Assignee: Ceo Tool Co., Ltd.

(21) Appl. No.: 12/590,887

(22) Filed: Nov. 16, 2009

(51) Int. Cl. B25B 13/46; B25B 13/48

(52) U.S. Cl. 81/58.2

(57) ABSTRACT

An open end ratchet wrench includes a socket member rotatably received in an opened head member and having a number of teeth and having an open notch for selectively aligning with an open slot of the head member, a pawl engaged in the head member and having a toothed end for selectively engaging with the teeth of the socket member and for allowing the socket member to be rotated in one direction by the head member, and a retaining ring engaged with the pawl and engaged with the inner peripheral recess of the wrench head member for retaining the pawl to the wrench head member and for allowing the pawl to be engaged with the teeth of the socket member, and a spring biasing member biases the pawl to engage with the teeth of the socket member.

### BACKGROUND OF THE INVENTION

1. Field of the Invention

The present invention relates to an open end ratchet wrench, and more particularly to an open end ratchet wrench including an improved structure for stably anchoring and retaining the spring-biased pawl members in the wrench head and for preventing the spring-biased pawl members from being moved or disengaged from the wrench head, and including a spring biasing member or retaining ring engaged with the pawl members for suitably biasing or forcing the pawl members to engage with a socket member that is rotatably received or engaged within the chamber of the wrench head.

2. Description of the Prior Art

Typical open end ratchet wrenches comprise an open wrench head member including an opening formed therein for receiving a socket member, and two spring-biased pawls engaged in the wrench head member and biased to engage with a number of teeth formed and provided around the socket member, and a switch or actuating or operating member attached to the wrench head member and engaged with the teeth of the socket member for switching or determining the driving direction of the socket member by the wrench head member.

For example, U.S. Pat. No. 1,890,213 to Cameron et al. discloses one of the typical open ended reversible ratchet wrenches also comprising a socket member pivotally or rotatably received or engaged in a wrench head member and two spring-biased pawls biased to engage with the teeth formed and provided around the socket member.

However, the pawls and the spring biasing members may occupy a great volume or space in the wrench head member such that the strength of the wrench head member may be greatly decreased.

U.S. Pat. No. 2,401,128 to Anderson discloses another typical open end ratchet wrench comprising an open end jaw member pivotally or rotatably received or engaged in a socket member and a pair of spring-biased pawls engaged in the cylindrical housings and biased to engage with the teeth formed and provided around the jaw member.

However, the cylindrical housings for receiving the spring-biased pawls are extended out of the jaw member and may seriously interfere the operation of the typical open end ratchet wrench.

U.S. Pat. No. 2,578,410 to Filiatreault discloses a further typical open-ended ratchet wrench comprising a socket member pivotally or rotatably received or engaged in an open head member and a pair of spring-biased pawls engaged in the wrench head and/or wrench handle and biased to engage with the teeth formed and provided around the socket member.

However, the pawls and the spring biasing members may also occupy a great volume or space in the wrench socket member such that the strength of the wrench socket member may also be greatly decreased.

U.S. Pat. No. 2,693,123 to Fish discloses a still further typical open end ratchet wrench comprising a socket member pivotally or rotatably received or engaged in an open head member and a pair of spring-biased pawls engaged in the wrench head and/or wrench handle and biased to engage with the teeth formed and provided around the socket member.

However, the pawls and the spring biasing members may also occupy a great volume or space in the wrench socket member such that the strength of the wrench socket member may also be greatly decreased.

U.S. Pat. No. 2,699,082 to Viets discloses a still further typical open end ratchet wrench comprising a socket member pivotally or rotatably received or engaged in an open head member and a pair of spring-biased pawls engaged in the wrench head and/or wrench handle and biased to engage with the teeth formed and provided around the socket member.

However, the pawls and the spring biasing members may also occupy a great volume or space in the wrench socket member such that the strength of the wrench socket member may also be greatly decreased.

U.S. Pat. No. 3,175,434 to Bergquist discloses a still further typical open end ratchet wrench comprising a ratchet wheel pivotally or rotatably received or engaged in an open ratchet head member and a pair of spring-biased pawls engaged in the wrench head and/or wrench handle and biased to engage with the teeth formed and provided around the ratchet wheel.

However, the pawls and the spring biasing members may also occupy a great volume or space in the wrench ratchet wheel such that the strength of the wrench ratchet wheel may also be greatly decreased.

The present invention has arisen to mitigate and/or obviate the afore-described disadvantages of the conventional open end ratchet wrenches.

### SUMMARY OF THE INVENTION

The primary objective of the present invention is to provide an open end ratchet wrench including an improved structure for stably anchoring and retaining the spring-biased pawl member in the wrench head and for preventing the spring-biased pawl member from being moved or disengaged from the wrench head.

The other objective of the present invention is to provide an open end ratchet wrench including a spring biasing member or retaining ring engaged with the pawl members for suitably biasing or forcing the pawl members to engage with a socket member that is rotatably received or engaged within the chamber of the wrench head.

In accordance with one aspect of the invention, there is provided an open end ratchet wrench comprising a wrench head member including a chamber formed therein, and including a slot formed in the wrench head member and communicative with the chamber of the wrench head member for opening the wrench head member and for allowing an object to be engaged through the slot and into the chamber of the wrench head member, and including a compartment formed in the wrench head member and communicative with the chamber of the wrench head member, and including an inner peripheral recess formed in the wrench head member and communicative with the chamber of the wrench head member and also communicative with the compartment of the wrench head member, a socket member rotatably received in the chamber of the wrench head member and including a number of teeth formed around the socket member, and including a non-circular engaging hole formed therein, and including a notch formed in the socket member and communicative with the non-circular engaging hole of the socket member for selectively aligning with the slot of the wrench head member, and for allowing the object to be engaged through the slot and into the chamber of the wrench head member, a pawl engaged in the compartment of the wrench head member and including a planer end for preventing the pawl from being engaged with the teeth of the socket member, and including a toothed end for selectively engaging with the teeth of the socket member and for allowing the socket member to be rotated and driven in one direction by the wrench head member, and a retaining ring engaged with the pawl and engaged with the inner peripheral recess of the wrench head member for anchoring and retaining the pawl to the wrench head member and for allowing the pawl to be engaged with the teeth of the socket member, and a spring biasing member engaged with the pawl for biasing the pawl to engage with the teeth of the socket member.

The pawl includes a depression formed therein and facing toward the teeth of the socket member for engaging with the retaining ring. The socket member includes an outer peripheral flange extended radially and outwardly therefrom for rotating the socket member relative to the wrench head member.

The wrench head member includes an inner peripheral channel formed in the wrench head member and communicative with the chamber of the wrench head member, but not communicative with the slot of the wrench head member, and the socket member includes an outer peripheral groove formed in the socket member and communicative with the notch of the socket member, and a retaining ring engaged with the inner peripheral channel of the wrench head member and the outer peripheral groove of the socket member for allowing the socket member to be rotated relative to the wrench head member.

The socket member includes at least one cavity formed therein and communicative with the outer peripheral groove thereof, and the retaining ring includes at least one protrusion extended outwardly therefrom for partially extending into the slot of the wrench head member when the notch of the socket member is aligned with the slot of the wrench head member.

The socket member includes a ring member attached to the socket member and engaged with the wrench head member for coupling the socket member to the wrench head member, and the ring member includes a notch formed therein for selectively aligning with the slot of the wrench head member, and for allowing the object to be engaged through the slot and into the chamber of the wrench head member.

The wrench head member includes a second compartment formed in the wrench head member and communicative with the chamber of the wrench head member and located beside the compartment of the wrench head member, and a second pawl is engaged in the second compartment of the wrench head member and includes a planer end for preventing the pawl from being engaged with the teeth of the socket member, and includes a toothed end for selectively engaging with the teeth of the socket member, and a second spring biasing member is engaged with the second pawl for biasing the second pawl to engage with the teeth of the socket member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an open end ratchet wrench in accordance with the present invention;

FIG. 2 is an enlarged partial perspective view illustrating the socket member of the open end ratchet wrench;

FIG. 3 is a perspective view of the open end ratchet wrench;

FIG. 4 is a partial cross sectional view of the open end ratchet wrench taken along lines 4-4 of FIG. 3;

FIG. 5 is an enlarged partial cross sectional view illustrating one of the spring-biased pawls of the ratchet wrench;

FIGS. 6, 7 are partial cross sectional views similar to FIG. 4, illustrating the operation of the open end ratchet wrench;

FIG. 8 is an enlarged partial cross sectional view similar to FIG. 5, illustrating the operation of the open end ratchet wrench; and

FIG. 9 is a perspective view illustrating the operation of the open end ratchet wrench.

### DETAILED DESCRIPTION OF THE PREFERRED EMBODIMENT

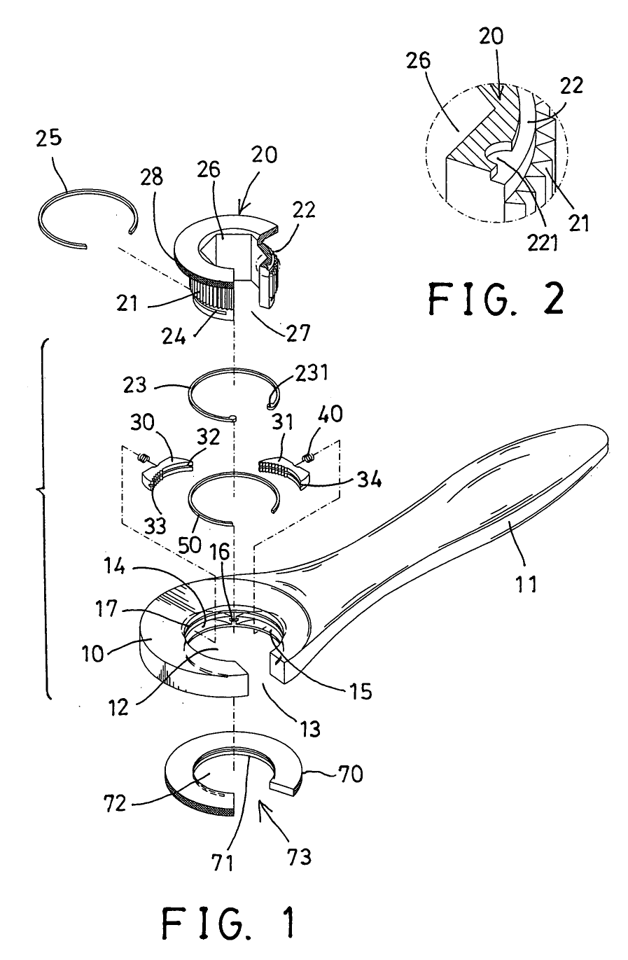

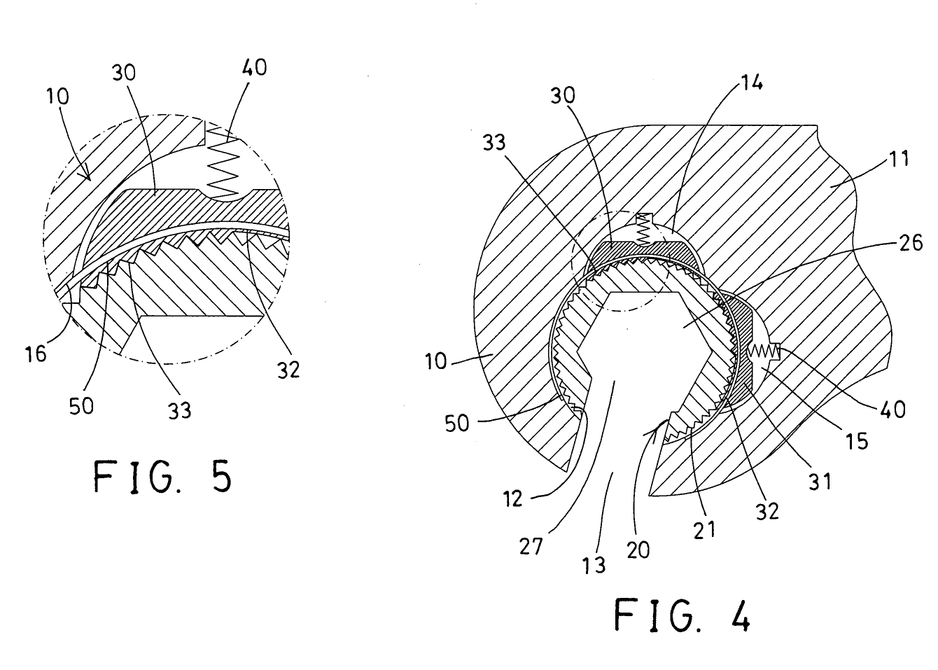

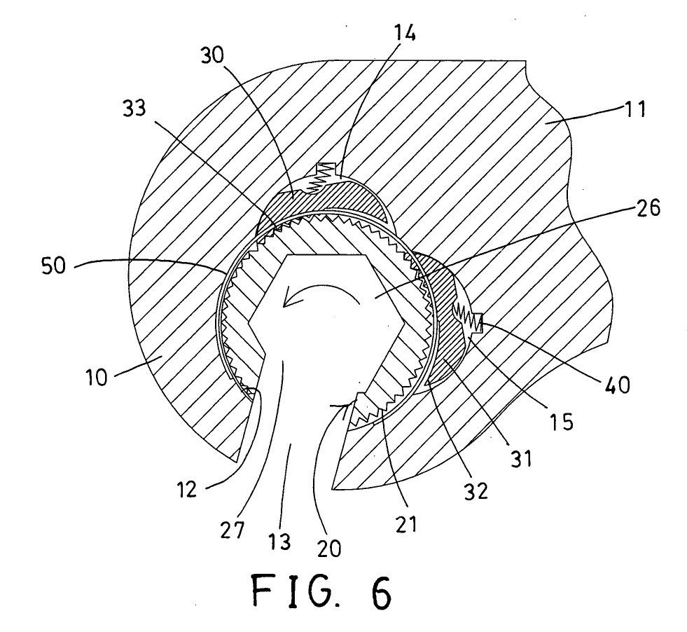

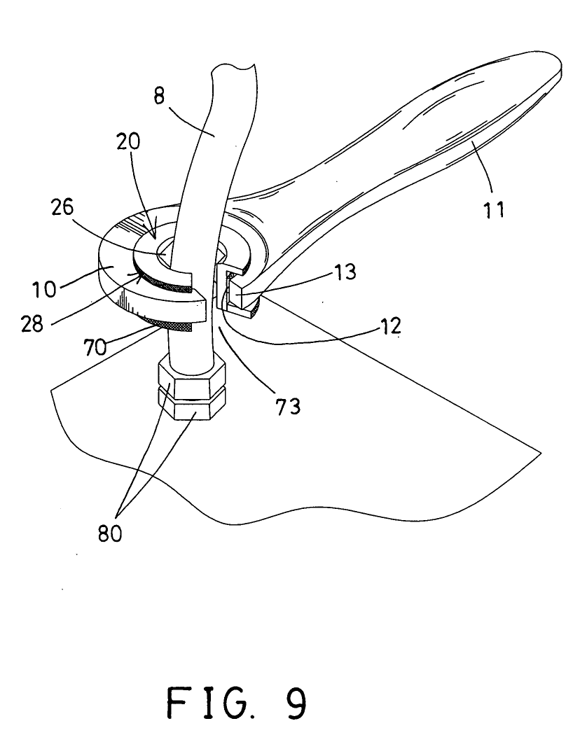

Referring to the drawings, and initially to FIGS. 1-4, an open end ratchet wrench in accordance with the present invention comprises an open wrench head member 10 formed or provided on one end of a wrench handle 11 and including a chamber 12 formed therein for pivotally or rotatably receiving a socket member 20, and including a slot 13 formed in the outer peripheral portion of the wrench head member 10 and communicative with the chamber 12 of the wrench head member 10 for allowing various objects, such as wires or cables 8 and/or lock nuts 80 (FIG. 9) and/or fasteners (not shown) and/or other tool members (not shown) to be engaged through the slot 13 of the wrench head member 10, and then to be engaged in the chamber 12 of the wrench head member 10, and then to be rotated or driven by the wrench head member 10.

The wrench head member 10 further includes one or more (such as two) compartments 14, 15 formed in the wrench head member 10 and communicative with the chamber 12 of the wrench head member 10, and an inner peripheral recess 16 also formed in the wrench head member 10 and communicative with the chamber 12 of the wrench head member 10 and also communicative with the compartments 14, 15 of the wrench head member 10, but not communicative with the slot 13 of the wrench head member 10, and an inner peripheral channel 17 also formed in the wrench head member 10 and communicative with the chamber 12 of the wrench head member 10, but not communicative with the slot 13 of the wrench head member 10, and offset from the compartments 14, 15 of the wrench head member 10.

The socket member 20 includes a number of teeth 21 formed and provided around the socket member 20, and includes an outer peripheral groove 22 formed therein for receiving or engaging with a retaining ring 23 which is stably engaged with the inner peripheral channel 17 of the wrench head member 10 for pivotally or rotatably attaching or mounting or coupling the socket member 20 to the wrench head member 10 and for preventing the socket member 20 from being moved or disengaged from the wrench head member 10, and may further include a further outer peripheral groove 24 formed therein for receiving or engaging with another retaining ring 25 which is engaged with an inner peripheral slot 71 of a ferrule or ring member 70, and the ring member 70 is contacted or engaged with the wrench head member 10 for further stably or solidly attaching or mounting or coupling the socket member 20 to the wrench head member 10.

For example, the ring member 70 includes a bore 72 formed therein and communicative with the inner peripheral slot 71 of the ring member 70, and includes a notch 73 formed therein and communicative with the bore 72 of the ring member 70 for selectively aligning with the slot 13 of the wrench head member 10, and for allowing various objects or wires or cables 8 to be engaged through the slot 13 of the wrench head member 10, and then to be engaged in the chamber 12 of the wrench head member 10. The socket member 20 includes a non-circular engaging hole 26 formed therein for receiving or engaging with the lock nuts 80 or fasteners or other tool members and for driving or rotating the lock nuts 80 or fasteners or other tool members.

The socket member 20 also includes a notch 27 formed therein and communicative with the non-circular engaging hole 26 of the socket member 20 for selectively aligning with the slot 13 of the wrench head member 10, and for allowing various objects or wires or cables 8 to be engaged through the slot 13 of the wrench head member 10, and then to be engaged in the chamber 12 of the wrench head member 10. It is to be noted that the outer peripheral groove 24 of the socket member 20 is not communicative with the notch 27 of the socket member 20, and the inner peripheral slot 71 of the ring member 70 is also not communicative with the notch 73 of the ring member 70 such that the retaining ring 25 may be stably or solidly retained and anchored between the socket member 20 and the ring member 70 and such that the ring member 70 may be stably or solidly attached or secured to the socket member 20, and such that the notch 73 of the ring member 70 may be prevented from being offset from the notch 27 of the socket member 20.

It is preferable that the socket member 20 includes one or more (such as two) cavities 221 formed therein (FIG. 2) and communicative with the two end portions of the outer peripheral groove 22 thereof for engaging with the protrusions 231 (FIG. 1) that are extended outwardly from the end portions of the retaining ring 23, the protrusions 231 of the retaining ring 23 are partially extended out of the cavities 221 of the socket member 20 for allowing the protrusions 231 of the retaining ring 23 to be partially extended or engaged into the slot 13 of the wrench head member 10 when the notch 27 of the socket member 20 is aligned with the slot 13 of the wrench head member 10 and to generate a click sound in order to indicate that the notch 27 of the socket member 20 is aligned with the slot 13 of the wrench head member 10.

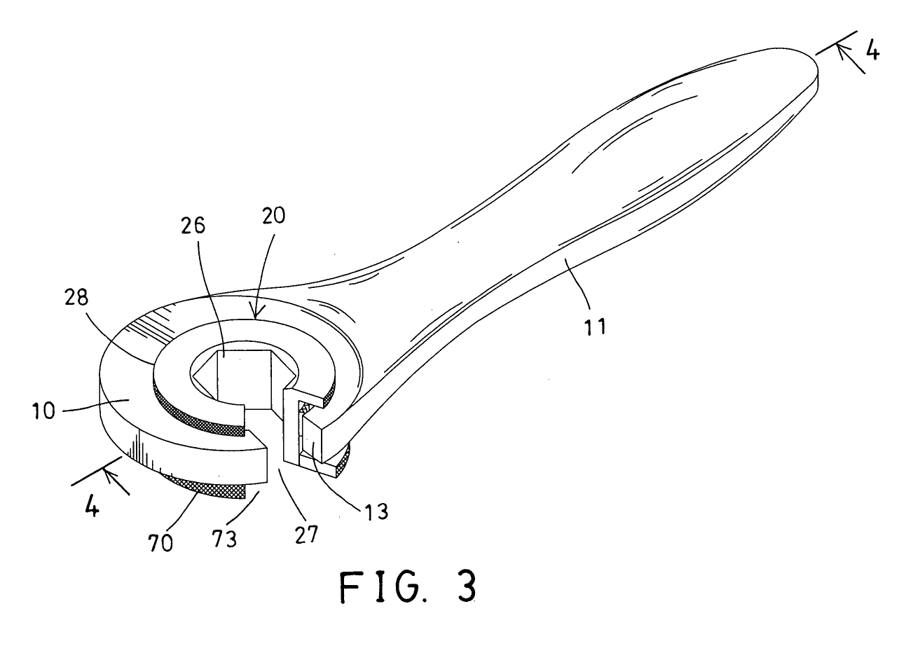

The outer peripheral groove 22 of the socket member 20 is communicative with the notch 27 of the socket member 20 for allowing the socket member 20 to be rotated relative to the retaining ring 23 and the wrench head member 10. The socket member 20 may further include an outer peripheral flange 28 extended radially and outwardly therefrom. The socket member 20 and the ring member 70 may be rotated relative to the wrench head member 10 with either the outer peripheral flange 28 of the socket member 20 or the ring member 70 in order to selectively align the notch 27 of the socket member 20 and the notch 73 of the ring member 70 with the slot 13 of the wrench head member 10 (FIGS. 3-4, 6-7 and 9), and for allowing various objects or wires or cables 8 to be engaged through the slot 13 of the wrench head member 10, and then to be engaged in the chamber 12 of the wrench head member 10.

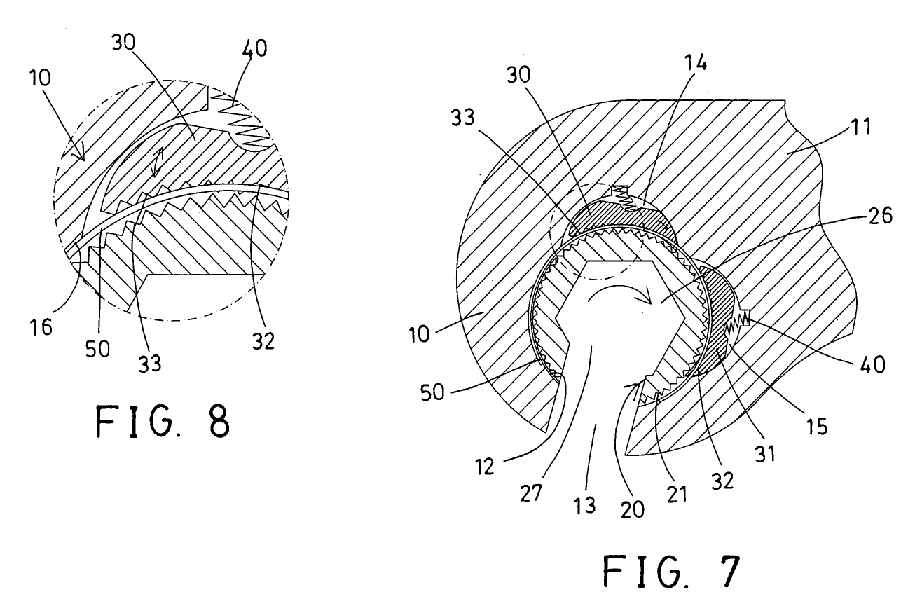

One or more (such as two) pawls 30, 31 are provided and engaged in the compartments 14, 15 of the wrench head member 10 respectively, and each include a planer end 32 for preventing the pawls 30, 31 from being engaged with the teeth 21 of the socket member 20 (FIGS. 7, 8), and each include one or more teeth 33 or a toothed end 33 for selectively engaging with the teeth 21 of the socket member 20 (FIG. 6) and for allowing the socket member 20 to be rotated or driven in one direction by the wrench head member 10 and the wrench handle 11. The pawls 30, 31 are arranged in the same direction for increasing the driving torque of the socket member 20 by the wrench head member 10 and the wrench handle 11.

It is preferable that the compartments 14, 15 of the wrench head member 10 and the pawls 30, 31 are disposed or positioned and arranged in the same height relative to the socket member 20 and the wrench head member 10 for allowing the teeth 33 or the toothed end 33 of the pawls 30, 31 to be solidly engaged with the teeth 21 of the socket member 20. The pawls 30, 31 each include an opened depression 34 formed therein, such as formed in the inner portions of the pawls 30, 31 and facing toward the teeth 21 of the socket member 20, and a spring biasing member or retaining ring 50 that may be easily and quickly engaged with the opened depression 34 of each pawl 30, 31 and also engaged with the inner peripheral recess 16 of the wrench head member 10 for anchoring and retaining the pawls 30, 31 to the wrench head member 10.

One or more (such as two) spring biasing members 40 are further provided and engaged in the pawls 30, 31 respectively for biasing either the planer ends 32 or the teeth 33 or the toothed ends 33 of the pawls 30, 31 to engage with the teeth 21 of the socket member 20. It is to be noted that the spring biasing members 40 are engaged with the pawls 30, 31 and occupy a relatively smaller space or volume and such that the strength of the wrench head member 10 may be suitably increased. In addition, the retaining ring 50 may also occupy a relatively smaller space or volume and may evenly and suitably bias or force the pawls 30, 31 to engage with the teeth 21 of the socket member 20 in order to suitably control or determine the driving direction of the socket member 20 by the wrench head member 10 and the wrench handle 11.

The typical open end ratchet wrenches failed to provide a retaining ring 50 engaged with the pawls 30, 31 for stably anchoring and retaining the pawls 30, 31 to the wrench head member 10 and for allowing the pawls 30, 31 to be biased and forced to engage with the teeth 21 of the socket member 20 by the spring biasing members 40. In operation, as shown in FIG. 9, the wires or cables 8 may be easily and quickly engaged through the slot 13 of the wrench head member 10 and then engaged into the chamber 12 of the wrench head member 10 when the notch 27 of the socket member 20 and the notch 33 of the ring member 30 are aligned with the slot 13 of the wrench head member 10.

Accordingly, the open end ratchet wrench in accordance with the present invention includes an improved structure for stably anchoring and retaining the spring-biased pawl member in the wrench head and for preventing the spring-biased pawl member from being moved or disengaged from the wrench head, and includes a spring biasing member engaged with the pawl member and having two ends extended out of the pawl member and engaged with the wrench head for biasing or forcing the pawl member to engage with the teeth of the socket member that is rotatably received or engaged within the chamber of the wrench head.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An open end ratchet wrench comprising:
a wrench head member including a chamber formed therein, and including a slot formed in said wrench head member and communicative with said chamber of said wrench head member for opening said wrench head member and for allowing an object to be engaged through said slot and into said chamber of said wrench head member, and including a compartment formed in said wrench head member and communicative with said chamber of said wrench head member, and including an inner peripheral recess formed in said wrench head member and communicative with said chamber of said wrench head member and also communicative with said compartment of said wrench head member,
a socket member rotatably received in said chamber of said wrench head member and including a plurality of teeth formed around said socket member, and including a non-circular engaging hole formed therein, and including a notch formed in said socket member and communicative with said non-circular engaging hole of said socket member for selectively aligning with said slot of said wrench head member, and for allowing the object to be engaged through said slot and into said chamber of said wrench head member,
a pawl engaged in said compartment of said wrench head member and including a planer end for preventing said pawl from being engaged with said teeth of said socket member, and including a toothed end for selectively engaging with said teeth of said socket member and for allowing said socket member to be rotated and driven in one direction by said wrench head member,
a retaining ring engaged with the pawl and engaged with the inner peripheral recess of the wrench head member for anchoring and retaining the pawl to the wrench head member and for allowing the pawl to be engaged with the teeth of the socket member, and
a spring biasing member engaged with said pawl for biasing said pawl to engage with said teeth of said socket member.

2. The open end ratchet wrench as claimed in claim 1, wherein said pawl includes a depression formed therein and facing toward said teeth of said socket member for engaging with said retaining ring.

3. The open end ratchet wrench as claimed in claim 1, wherein said wrench head member includes an inner peripheral channel formed in said wrench head member and communicative with said chamber of said wrench head member, but not communicative with said slot of said wrench head member, and said socket member includes an outer peripheral groove formed in said socket member and communicative with said notch of said socket member, and a retaining ring engaged with said inner peripheral channel of said wrench head member and said outer peripheral groove of said socket member for allowing said socket member to be rotated relative to said wrench head member.

4. The open end ratchet wrench as claimed in claim 3, wherein said socket member includes at least one cavity formed therein and communicative with said outer peripheral groove thereof, and said retaining ring includes at least one protrusion extended outwardly therefrom for partially extending into said slot of said wrench head member when said notch of said socket member is aligned with said slot of said wrench head member.

5. The open end ratchet wrench as claimed in claim 1, wherein said socket member includes an outer peripheral flange extended radially and outwardly therefrom for rotating said socket member relative to said wrench head member.

6. The open end ratchet wrench as claimed in claim 1, wherein said socket member includes a ring member attached to said socket member and engaged with said wrench head member for coupling said socket member to said wrench head member, and said ring member includes a notch formed therein for selectively aligning with said slot of said wrench head member, and for allowing the object to be engaged through said slot and into said chamber of said wrench head member.

7. The open end ratchet wrench as claimed in claim 1, wherein said wrench head member includes a second compartment formed in said wrench head member and communicative with said chamber of said wrench head member and located beside said compartment of said wrench head member, and a second pawl is engaged in said second compartment of said wrench head member and includes a planer end for preventing said pawl from being engaged with said teeth of said socket member, and includes a toothed end for selectively engaging with said teeth of said socket member, and a second spring biasing member is engaged with said second pawl for biasing said second pawl to engage with said teeth of said socket member.
